(19) United States
(12) Patent Application Publication
(10) Pub. No.: US 2022/0405636 A1
(43) Pub. Date: Dec. 22, 2022

(54) MODEL INFERENCE DEVICE AND METHOD AND PROGRAM

(71) Applicant: Hitachi, Ltd., Tokyo (JP)

(72) Inventor: Kazuki HORIWAKI, Tokyo (JP)

(73) Assignee: Hitachi, Ltd., Tokyo (JP)

(21) Appl. No.: 17/685,142

(22) Filed: Mar. 2, 2022

(30) Foreign Application Priority Data
Jun. 22, 2021 (JP) 2021-103130

(51) Int. Cl. G06N 20/00

(52) U.S. Cl. CPC G06N 20/00

(57) ABSTRACT

An object of the present invention is to execute model update more appropriately to reduce the cost in the update. To solve the above problems, the present invention provides a model update and development system that is a model inference device that infers a model in machine learning, the model update and development system having a storage unit that stores an unupdated model as a model before update and an updated model, a feature amount data creation unit that creates a feature amount indicating a feature related to an association between the unupdated model and the updated model in data used in updating the model, an update learning model building unit that builds an update learning model learning an updating method of the update on the basis of the unupdated model, the updated model, and the feature amount, and an update learning model inference unit that infers the predetermined model on the basis of the update learning model.

### CLAIM OF PRIORITY

The present application claims priority from Japanese Patent Application JP 2021-103130 filed on Jun. 22, 2021, the content of which are hereby incorporated by references into this application.

### BACKGROUND OF THE INVENTION

The present invention relates to the management of a so-called machine learning model. More specifically, the present invention relates to a technique for managing a model in various tasks, such as manufacture, design, and maintenance tasks. Note that the management of the model includes updating and developing the model.

At present, the machine learning model (hereinafter, the model) built on a computer system is used for assisting various tasks. Also, for the more efficient task assistance, the model is updated and developed to other bases, other tasks, and the like.

Such update and development build the model on the basis of data acquired in performing the task and know-how that an engineer, an operator, and the like have. And, when the accuracy of the model when applied to the task is deteriorated, the model is updated for the purpose of improving the accuracy of the model. Also, the built model is made good use of in the task to develop the acquired result to other bases, other tasks, and the like.

A conventional art literature about such the update and development of the model, there is Japanese Unexamined Patent Application Publication No. 2019-79216. Japanese Unexamined Patent Application Publication No. 2019-79216 describes that a result acquired by a past analysis task is stored on a database, and at the time of model update, a case similar to the corresponding case is searched for from on the database, thereby performing the model update and development from the search result.

Also, as another conventional art literature, there is Japanese Unexamined Patent Application Publication No. 2009-223362. Japanese Unexamined Patent Application Publication No. 2009-223362 describes that a graphical model called a Bayesian network is created on the basis of previous knowledge, and when a failure event occurs, the Bayesian network of a subgraph corresponding to the corresponding event is built and updated, so that thereafter, a probability distribution is updated with respect to a previously created model.

### SUMMARY OF THE INVENTION

Here, the management of the model including the update and development of the model requires the management of a parameter according to the state of a destination to which the model is applied. For example, the manufacture industry uses the model called a statistical model or the machine learning model for problem solution, but is required to update and manage the parameter used in the model according to the type of a device, a using environment, and the like.

Consequently, the management of the model is required to perform the management including the update of the parameter. In particular, when the model is applied to a device group ranged with a wide variety in small quantities, the parameter is required to be managed and updated for each device. Due to this, the number of parameters to be managed becomes enormous, and as a result, the management cost becomes high.

Here, in Japanese Unexamined Patent Application Publication No. 2019-79216, plural data resources and analysis results are received as inputs, are converted to event data that are easily calculated by the computer, and are stored onto the database. Then, at the time of the model update, a case similar to the corresponding case can be searched for from on the database, and the result can be reflected to the model update. However, in Japanese Unexamined Patent Application Publication No. 2019-79216, all cases similar to the corresponding case are required to be previously stored onto the database, and when the corresponding case is not present on the database, the model is required to be restructured, so that the number of parameters due to the type of the device, the using environment, and the like cannot be reduced.

Also, in Japanese Unexamined Patent Application Publication No. 2009-223362, the graphical model including a target model is previously built, its submodel is updated, and the update result is reflected to the original model, so that the parameter management cost can be reduced. However, in Japanese Unexamined Patent Application Publication No. 2009-223362, it is necessary to build the model including each target model and repeat, for each parameter setting of the model, the parameter setting and evaluation loop, so that the management cost becomes high.

As described above, in Japanese Unexamined Patent Application Publication No. 2019-79216 and Japanese Unexamined Patent Application Publication No. 2009-223362, the parameter can be updated, but the operation repeating the model restructuring and the parameter adjustment is required with respect to a wide variety of conditions, so that the cost for the model update becomes huge.

Accordingly, an object of the present invention is to execute model update more appropriately to reduce the cost thereof.

To solve the above problems, the present invention learns the update itself of a model. As an example of this, the present invention represents the determination itself of conditions for performing parameter adjustment, management, and update by a statistical model or a machine learning model, and learns the statistical model or the machine learning model. Then, this result can be reflected to the update and development of the model.

More specifically, a model inference device that infers a model in machine learning has a storage unit that stores an unupdated model as a model before update and an updated model, a feature amount data creation unit that creates a feature amount indicating a feature related to an association between the unupdated model and the updated model in data used in updating the model, an update learning model building unit that builds an update learning model learning an updating method of the update on the basis of the unupdated model, the updated model, and the feature amount, and an update learning model inference unit that infers the predetermined model on the basis of the update learning model.

The present invention also includes a model inference method using the model inference device. Further, the present invention includes a program for causing a computer as the model inference device to function and a program product, such as a storage medium storing the program.

According to the representative embodiment of the present invention, the present invention can execute model update more appropriately to reduce the cost of the model update.

Problems, configurations, and effects other than the above will be apparent from the description of the following embodiment.

### BRIEF DESCRIPTION OF THE DRAWINGS

FIG. 1 is a diagram illustrating a configuration example of a model update and development system according to an embodiment of the present invention;

FIG. 2 is a diagram illustrating a display example of a model to be updated and an updated model in a model display unit according to an embodiment of the present invention;

FIG. 3 is a diagram illustrating a display example displaying parameter information in a parameter display unit according to an embodiment of the present invention;

FIG. 4 is a diagram illustrating a display example displaying information managing an update learning model in an update learning model selection unit according to an embodiment of the present invention;

FIG. 5 is a diagram illustrating a display example in a structure form of the update learning model in an update learning model display unit according to an embodiment of the present invention;

FIG. 6 is a diagram illustrating a display example displaying the parameter information of the update learning model in an update learning model parameter display unit according to an embodiment of the present invention;

FIG. 7 is a flowchart illustrating the processing flow for learning the update learning model according to an embodiment of the present invention;

FIG. 8 is a flowchart illustrating the detailed processing flow of step S4 (for learning the update learning model) according to an embodiment of the present invention;

FIG. 9 is a flowchart illustrating an example of the processing flow of an update learning model inference unit in an inference phase according to an embodiment of the present invention;

FIG. 10 is a flowchart illustrating an example of the processing flow of a control unit in a development phase according to an embodiment of the present invention;

FIG. 11 is a diagram illustrating a data structure example in a model network structure according to an embodiment of the present invention;

FIG. 12 is a diagram illustrating a data structure example in a structure form of the update learning model according to an embodiment of the present invention;

FIG. 13 is a diagram illustrating a structure example of data in building the unupdated model, data in building the updated model, or data acquired in operation according to an embodiment of the present invention;

FIG. 14 is a diagram illustrating a data structure example of edge information as the parameters of a model according to an embodiment of the present invention;

FIG. 15 is a diagram illustrating a data structure example of the parameter information of the update learning model according to an embodiment of the present invention; and

FIG. 16 is a diagram illustrating an implementation example according to an embodiment of the present invention.

### DETAILED DESCRIPTION OF THE PREFERRED EMBODIMENTS

Hereinbelow, an embodiment of the present invention will be described with reference to the drawings. Note that in the respective drawings, the same parts are indicated by the same reference numerals as a rule, and the repeated description thereof is omitted. Also, in this embodiment, a graphical model is taken as an example of a model to be updated, and a graph neural network is adopted as an update learning model, but the present invention is not limited thereto.

### (1) System Configuration

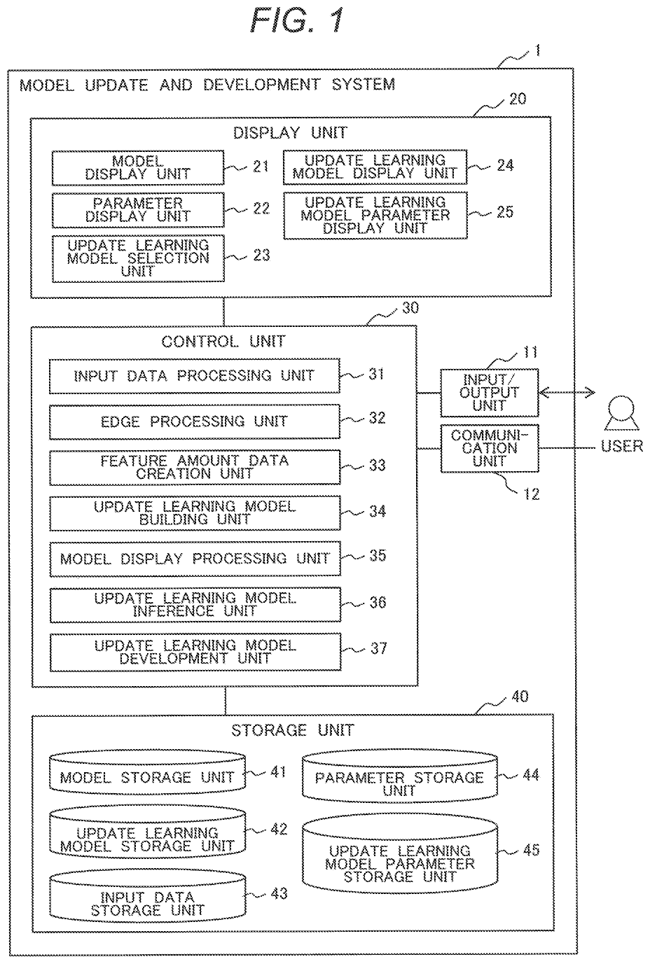

FIG. 1 is a diagram illustrating a configuration example of a model update and development system 1 according to this embodiment. That is, the model update and development system 1 is an example of a model inference device of the present invention. The model update and development system 1 can be configured of a typical computer (such as a PC), and achieves, for example, processes described later by processes for executing software programs.

The model update and development system 1 is configured of an input/output unit 11, a communication unit 12, a display unit 20, a control unit 30, a storage unit 40, a bus, and the like. Here, the input/output unit 11 receives an operation by a user, and outputs information to the user. That is, the input/output unit 11 needs only to have an input function and an output function. Thus, the input/output unit 11 can be achieved by individual devices of an input device having the input function and an output device having the output function.

For example, the input function receives the following inputs.

(A) The designation of the model to be model updated;
(B) The model setting item used in updating the model called the update learning model;
(C) The input of the item on a graphical user interface (GUI) that is a sort of the output device;
(D) The selection of the model to be model updated and the update learning model; and
(E) The input of observation data measured in an environment using the model to be model updated.

Also, examples of the output function include learning the update learning model and outputting an inference result using the update learning model. And, the input/output unit 11 can be achieved by, for example, a keyboard, a mouse, a display, a printer, and the like.

Also, the communication unit 12 includes a communication interface device with respect to a communication network outside the model update and development system 1, and communicates with an external server, a manufacture device, and the like. For this, the communication unit 12 may acquire and refer to monitor data, manufacture process information, and the like from the external server, the manufacture device, and the like according to control from the control unit 30.

Also, the model update and development system 1 may have a configuration that configures the GUI on the screen of the display unit 20 and displays various information. Note that the display unit 20 may be achieved as the output device, or may be configured individually. When the display unit 20 is configured individually, the input/output unit 11 has a function of connection with a terminal device used by the user. In this case, the display unit 20 can be omitted. In this case, the input/output unit 11 and the communication unit 12 can be configured as one portion.

The control unit 30 is configured of, for example, a known element, such as a processor like a CPU and a memory, such as a RAM and a ROM. That is, the control unit 30 achieves the process of each unit described later according to the program stored in the memory.

That is, the control unit 30 has an input data processing unit 31, an edge processing unit 32, a feature amount data creation unit 33, an update learning model building unit 34, a model display processing unit 35, an update learning model inference unit 36, and an update learning model development unit 37, and performs the main processes of this embodiment.

### (2) Display Contents

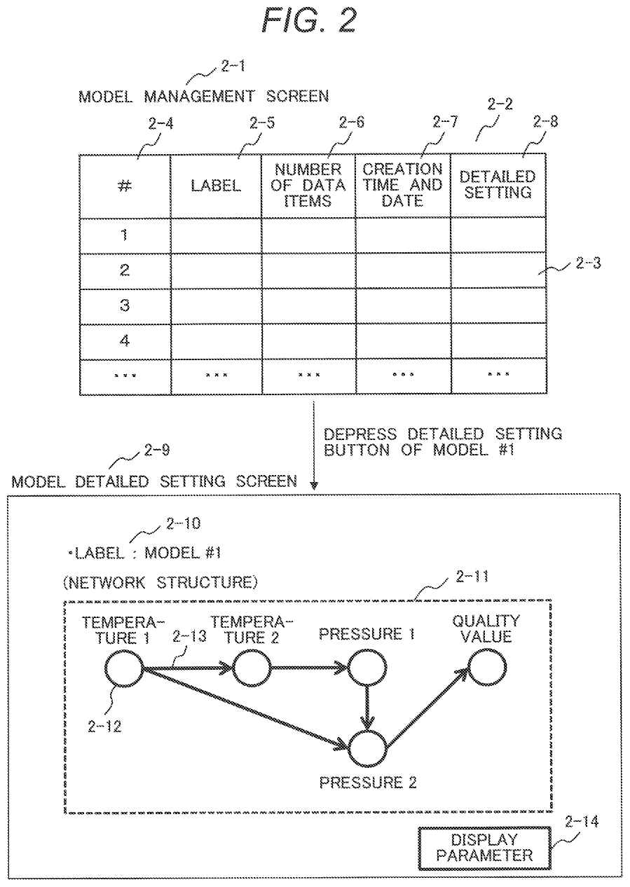

Next, the display contents of this embodiment will be described with reference to FIGS. 2 to 6. In this embodiment, a GUI screen example displayed by the display unit 20 will be described, but the same output and display are enabled via the input/output unit 11 and the communication unit 12.

The display unit 20 is mainly configured of a model display unit 21, a parameter display unit 22, an update learning model selection unit 23, an update learning model display unit 24, and an update learning model parameter display unit 25. However, these may be achieved as the functions of the control unit 30. That is, the GUI screen of the display unit 20 can be created by the control unit 30 according to the program achieving each unit, and be displayed on the display unit 20.

First, FIG. 2 is a diagram illustrating a display example of the model to be updated and an updated model in the model display unit 21. The model display unit 21 displays a screen in a table form called a model management screen (2-1). The model management screen (2-1) is a screen in a table form including header information (2-2) about the model and a value (2-3) with respect to the header. The header information (2-2) mainly includes a header (2-4) indicating a number in the row direction, a label (2-5) identifying the model, the number of data items (2-6) used in the model, a creation time and date (2-7) of the model, and a detailed setting link (2-8). The header information (2-2) is only an example, and the present invention is not limited thereto.

Also, the header (2-4) indicating a number in the row direction indicates a row number in displaying each stored model. The label (2-5) is a label identifying the model stored in a model storage unit 41 and a parameter storage unit 44, and indicates information about each model. The number of data items (2-6) indicates the number of nodes of a network structure described by 11-1 of the model storage unit 41 and the number of data items of the header (14-3 and 14-4) described in the parameter storage unit 44.

The creation time and date (2-7) indicates a time and date on which the model is created. The detailed setting link (2-8) displays a button for change to a screen displaying the detailed setting of each model. A model detailed setting screen (2-9) of each model displays a network structure (2-11) of the target model. The network structure (2-11) displayed displays information stored in the model storage unit 41. A label (2-10) of the network structure corresponds to the label (2-5) of the model management screen (2-1). The network structure (2-11) displays a network structure configured of a node (2-12) indicating each data item and edge information (2-13) indicating a relationship between the data items.

Also, the node (2-12) corresponds to 11-3 of the model storage unit 41, and the edge information corresponds to 11-4 of the model storage unit 41. A parameter display button (2-14) is a button for change to the parameter display unit 22 that is a screen displaying the parameter of the target model.

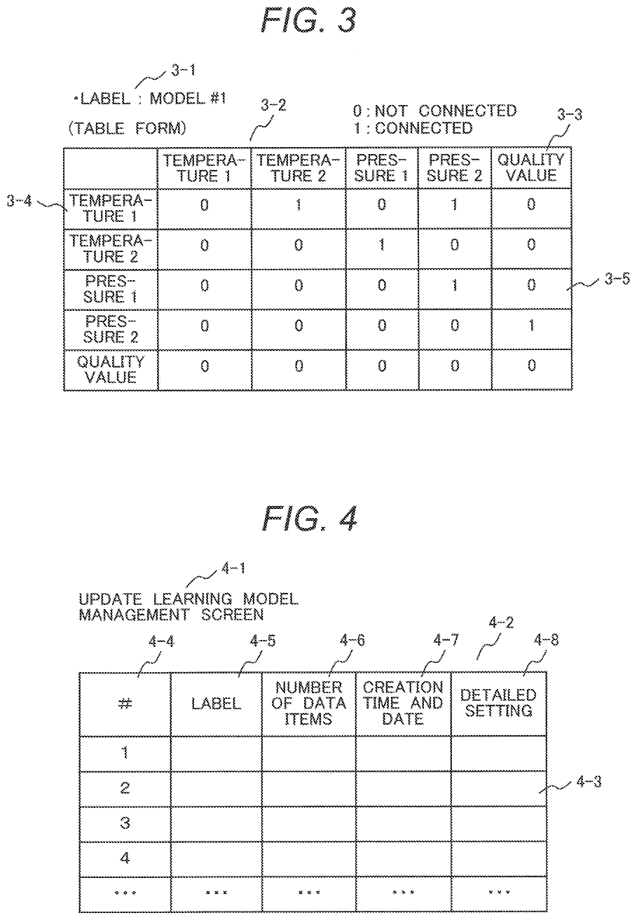

Next, the parameter display unit 22 will be described with reference to FIG. 3. FIG. 3 is a diagram illustrating a display example displaying parameter information in the parameter display unit according to this embodiment. The parameter display unit 22 displays the parameter of the model to be updated and the updated model.

In FIG. 3, the parameter display unit 22 changes the screen by depressing the parameter display button (2-14) on the model detailed setting screen (2-9) of the model management screen (2-1). Also, the parameter display unit 22 displays a label (3-1) indicating the target model and the parameter information (in this example, the edge information) in a table form (3-2).

Here, the table form (3-2) displays the edge information (2-13) between the respective data items of the model display unit 21 in a table form. The first row (3-3) and the first column (3-4) in the table are the data items used in the target model, and correspond to the 14-3 and 14-4 of the parameter storage unit 44. Edge information (3-5) between the data items indicates the information of 14-5 stored in the parameter storage unit 44.

Next, the update learning model selection unit 23 will be described with reference to FIG. 4. FIG. 4 is a diagram illustrating a display example displaying information managing the update learning model in the update learning model selection unit 23 according to this embodiment. Here, the update learning model selection unit 23 calls a model for learning update the update leaning model, and displays a screen selecting plural update learning models.

The update learning model selection unit 23 displays an update learning model management screen (4-1) described in a table form. Here, the update learning model management screen (4-1) represents a table configured of header information (4-2) and a value (4-3) corresponding to the header. The header information (4-2) has a row number (4-4) of each update learning model, a label (4-5) identifying the update learning model, the number of data items (4-6) handled by the update learning model, a creation time and date (4-7) on which the update learning model is created, and detailed setting (4-8) describing a button for change to a screen describing the detailed information of the update learning model.

The header information (4-2) is only an example, and the present invention is not limited thereto. The row number (4-4) as the header indicating a number in the row direction indicates a row number in displaying each stored update learning model. The label (4-5) indicates a label identifying the model stored in the model storage unit 41 and the update learning model parameter storage unit 45. The number of data items (4-6) describes the number of nodes in the input layer of the graphical neural network structure described by 12-1 of the model storage unit 41. The creation time and date (4-7) indicates a time and date on which the update learning model is created. The detailed setting (4-8) describes a button for change to a screen displaying the detailed setting of each model.

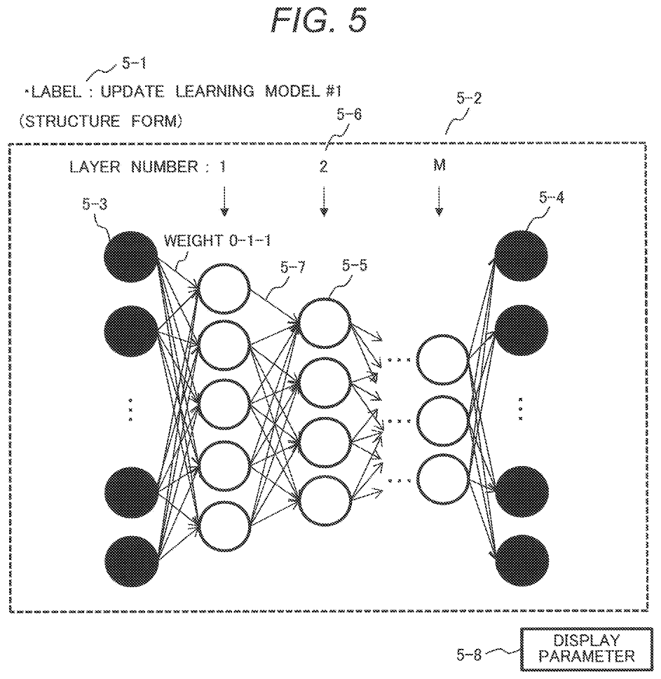

Next, the update learning model display unit 24 will be described with reference to FIG. 5. FIG. 5 is a diagram illustrating a display example in a structure form of the update learning model in the update learning model display unit 24 according to this embodiment.

The update learning model display unit 24 displays the update learning model. Specifically, the update learning model display unit 24 displays a label (5-1) and a structure form (5-2) of the target update learning model stored in the update learning model storage unit 42. Here, the label (5-1) corresponds to the label (12-1) of the update learning model storage unit. Also, the structure form (5-2) corresponds to a structure form (12-2) of the update learning model storage unit 42. The structure form (5-2) is configured of an input layer (5-3) of the update learning model, an output layer (5-4) of the update learning model, an intermediate layer (5-5) of the update learning model, a layer number (5-6) of the intermediate layer of the update learning model, and edge information (5-7) indicating a connection between the respective nodes of the update learning model.

Also, the input layer (5-3) of the update learning model corresponds to 12-3 of the update learning model storage unit 42. The output layer (5-4) of the update learning model corresponds to 12-4 of the update learning model storage unit 42. The intermediate layer (5-5) of the update learning model corresponds to 12-5 of the update learning model storage unit 42. The layer number (5-6) of the intermediate layer of the update learning model corresponds to 12-6 of the update learning model storage unit 42. The edge information (5-7) indicating a connection between the nodes of the update learning model corresponds to 12-7 of the update learning model storage unit 42. A parameter display button (5-8) is a button for performing change to the update learning model parameter display unit 25 as a screen having a table describing a weight between the respective nodes that is the parameter of the update learning model.

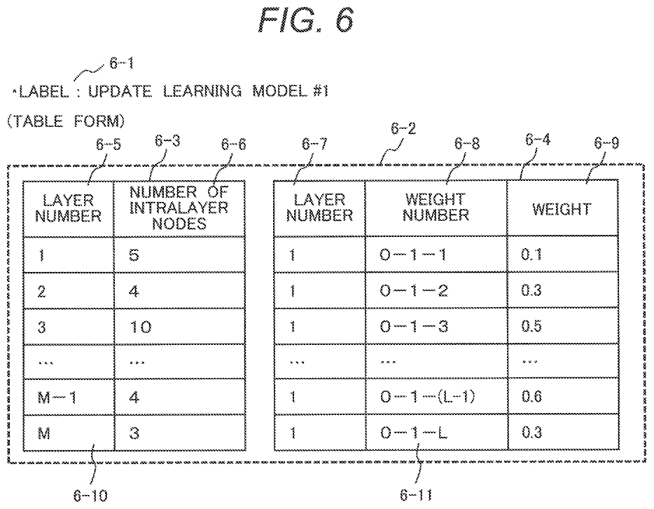

Next, the update learning model parameter display unit 25 will be described with reference to FIG. 6. FIG. 6 is a diagram illustrating a display example displaying the parameter information of the update learning model in the update learning model parameter display unit 25 according to this embodiment.

The update learning model parameter display unit 25 displays the parameter of the update learning model. Specifically, the update learning model parameter display unit 25 is configured of a label (6-1) identifying the update learning model and a screen (6-2) storing the parameter of the update learning model in a table form. Here, the label (6-1) is the label of the target model, corresponds to the label (5-1) of the model displayed in depressing the parameter display button (5-8) in the update learning model display unit 24, and corresponds to a label (15-1) stored in the update learning model parameter storage unit 45. The screen (6-2) in a table form is configured of two tables each including a table (6-3) of a layer number and the number of intralayer nodes, and a table (6-4) having a layer number, a weight number, and the value of a weight corresponding to the weight number. The table (6-3) of a layer number and the number of intralayer nodes has, as headers, a layer number (6-5) and the number of intralayer nodes (6-6), and describes each value in 6-10. The table (6-4) having a layer number, a weight number, and the value of a weight corresponding to the weight number has, as headers, a layer number (6-7), a weight number (6-8), and a weight (6-9), and each value is described in 6-11.

### (3) Control Unit 30

Next, the control unit 30 will be described. As illustrated in FIG. 1, the control unit 30 is mainly configured of the input data processing unit 31, the edge processing unit 32, the feature amount data creation unit 33, the update learning model building unit 34, the model display processing unit 35, the update learning model inference unit 36, and the update learning model development unit 37. These are respective function blocks, and as described above, the processes thereof can also be executed according to the programs. This will be described later.

Here, in the update learning model targeted in this embodiment, three phases called learning, inference, and development are present. The learning is a phase learning the optimum parameters of the update learning model by a past model group and data group. Also, the inference is a phase using the update learning model parameter-adjusted by the learning to infer, from an inputted model and data, information that is required to be updated and output the inferred information. The development is a phase managing the update learning model created in the past and applying the update learning model to other models.

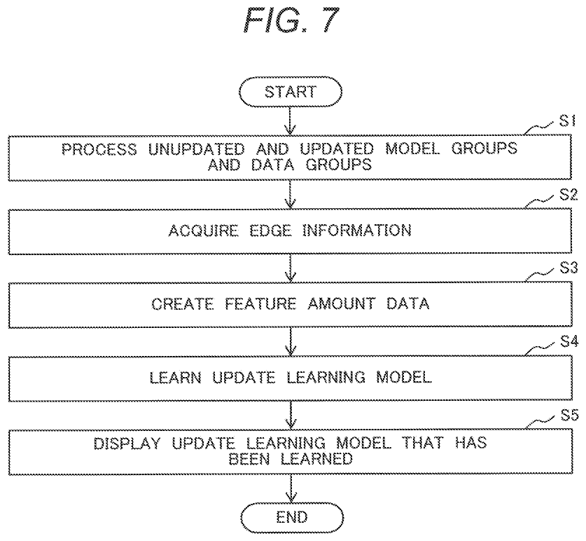

An example of the processing flow of the control unit 30 in the learning phase will be described with reference to FIG. 7. FIG. 7 is a flowchart illustrating the processing flow for learning the update learning model according to this embodiment.

First, the input data processing unit 31 processes the target model and the data thereof inputted to the model update and development system 1 (step S1). Here, the input data processing unit 31 receives, as the updating training data of the update learning model, the inputs of the model before update (unupdated model), the data used at the time of building the unupdated model (unupdated model building data), the data actually acquired by operating the unupdated model (updated model building data), and the model updated by using the updated model building data (updated model).

Here, as the number of inputs, plural unupdated models, plural unupdated model building data, plural updated models, and plural updated model building data can be inputted. Hereinafter, plural models are called a model group, and plural data are called a data group. Note that the data process in this step refers to various processes, such as a data preprocess, a statistical data process, such as the process and complementing of a missing value, and the process of an outlier value, and error check.

Next, the edge processing unit 32 acquires the edge information as graph information from the unupdated model group and the updated model group (step S2). Then, the feature amount data creation unit 33 creates feature amount data by using the unupdated model building data and the updated model building data (step S3). Here, the feature amount data represents a feature related to an association between the unupdated data and the updated model. As this example, it is possible to use a difference between the unupdated data and the updated model and a difference between the unupdated model building data and the updated model building data.

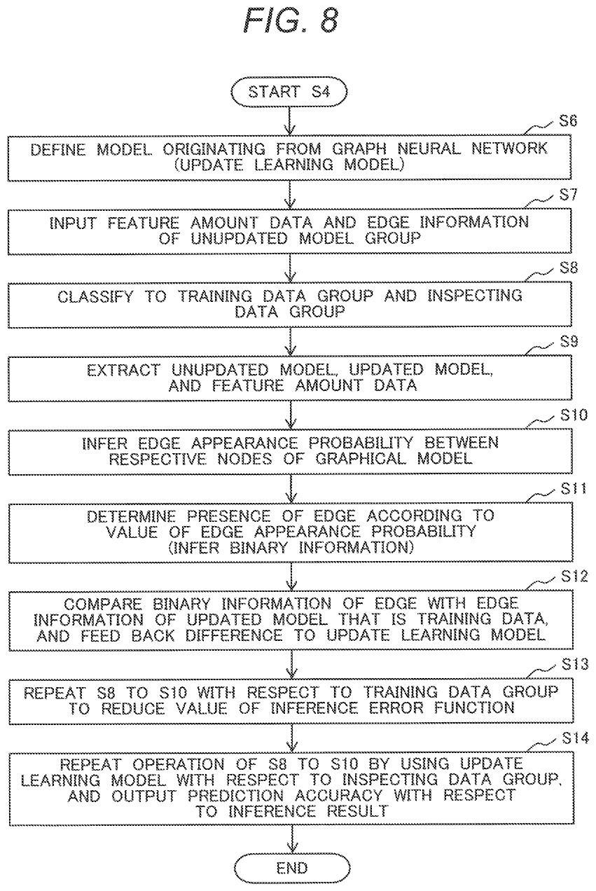

Next, the update learning model building unit 34 learns the update learning model (step S4). For this, the update learning model building unit 34 uses, as a base, the graph neural network. Then, the update learning model building unit 34 receives, as an input, the edge information of the unupdated model group processed in step S2, and uses the feature amount data created in step S3 to learn the model in which as the training data, the edge information of the updated model group processed in step S2 is used. Here, the model learned is called the update learning model. The detailed flow of step S4 will be described with reference to FIG. 8.

Finally, the model display processing unit 35 outputs, onto the screen, the update learning model that has been learned (step S5). Note that the update learning model may be outputted by the update learning model display unit 24 of the display unit 20.

Next, the detailed flow of step S4 will be described with reference to FIG. 8. FIG. 8 is a flowchart illustrating the detailed processing flow of step S4 (for learning the update learning model) according to this embodiment. First, the update learning model building unit 34 defines, as the update learning model, the model originating from the graph neural network (step S6). Here, a Graph Convolutional Neural Network (GCN) is taken as an example.

Next, the update learning model building unit 34 receives, as inputs, the feature amount data created from the unupdated model building data and the updated model building data created in step S3 and the unupdated model group with respect to the update learning model (step S7). The inputs mean explanation variables in the machine learning field.

Next, the update learning model building unit 34 uses, as the training data, the updated model group corresponding to the feature amount and the unupdated model group inputted in step S7, and classifies each pair of the unupdated model group or the updated model group and the feature amount into a training data group and an inspecting data group (step S8).

Next, the update learning model building unit 34 acquires the unupdated model, the updated model, and the feature amount data from the training data group (step S9). The acquiring method here is arbitrary, and may be performed randomly, in an ascending order, in a descending order, or by an acquiring method designated by the user, and the number of acquiring unupdated models, updated models, or feature amount data is not limited.

Next, the update learning model building unit 34 inputs, to the update learning model, the acquired unupdated model and the feature amount data corresponding thereto, and creates the feature amount from the update learning model. Then, the update learning model building unit 34 designates, from the feature amount, an edge appearance probability between the respective nodes of the updated model that is the target training data (step S10).

Next, the update learning model building unit 34 determines the presence of the edge according to the inferred edge appearance probability to infer binary information. For this, the update learning model building unit 34 compares the edge value with a threshold value previously set by the update learning model parameter display unit 25. When the edge value exceeds the threshold value, the update learning model building unit 34 determines that the edge is present, and causes, as the edge information, the edge information (binary information) between the target nodes to be 1. When the edge value does not exceed the threshold value, the update learning model building unit 34 determines that the edge is not present, and causes the edge information (binary information) between the target nodes to be 0.

These edge information items are called inference edge information. Note that the threshold value can also be set by the update learning model parameter display unit 25, or an appropriate threshold value can also be automatically set by the update learning model building unit 34, and the threshold value setting method is not limited to these two methods.

Next, the update learning model building unit 34 compares the inference edge information calculated in step S11 with the edge information processed from the updated model in step S2. Then, the update learning model building unit 34 feeds back difference information indicating the difference to the update learning model (step S12). Here, for a method for feeding back the difference information to the update learning model, it is possible to adopt a method by which for the difference information between the inference edge information and the edge information, a loss value is calculated by using, for example, a cross entropy and the value is fed back to the update learning model by an error back propagation method. However, this method is an example, and the present invention is not limited thereto.

Next, the update learning model building unit 34 repeatedly performs the operation in steps S8 to S10 with respect to each training data of the training data group extracted in step S9. By this, the update learning model building unit 34 performs the operation in steps S8 to S10 until the value of the inference error function of the set model becomes small so that the predetermined condition is satisfied (step S13). The number of times of learning can also be previously set by the update learning model parameter display unit 25, and can also be automatically set by the update learning model building unit 34, and the present invention is not limited to these two methods. Also, “the predetermined condition is satisfied” includes that the value of the inference error function is the threshold value or less and that the number of repetition of steps S8 to S10 is a fixed number of times or more.

Next, the update learning model building unit 34 repeats the operation of steps S8 to S10 by using the update learning model learned in steps S6 to S13 with respect to each of the inspecting data extracted in step S9. By this, the update learning model building unit 34 outputs a prediction accuracy with respect to the inference result (step S14).

Here, the display of the inference result may be performed by the update learning model selection unit 23 and the update learning model display unit 24. Note that the update learning model building unit 34 stores, in the update learning model storage unit 42, the prediction accuracy with respect to the inference result. Also, the update learning model building unit 34 stores, in the update learning model parameter storage unit 45, the information of the parameter and the like about the update learning model that has been learned. Further, the update learning model building unit 34 stores, in the update learning model storage unit 42, the unupdated model group, the updated model group, the created feature amount, and the learning conditions used for the update learning model. That is all for the description of FIG. 8.

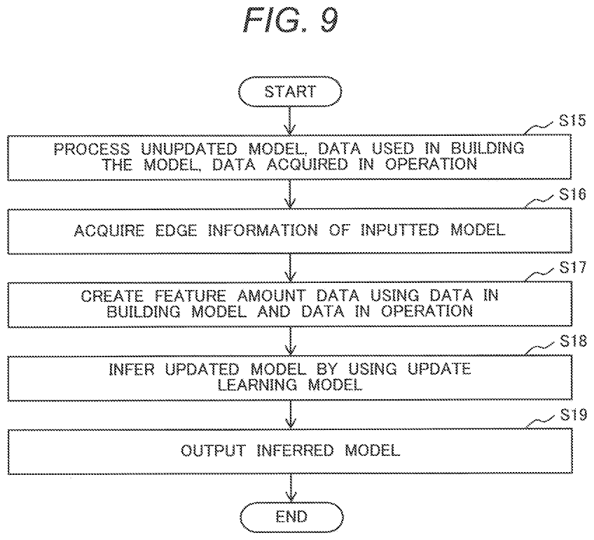

Next, FIG. 9 is a flowchart illustrating an example of the processing flow of the update learning model inference unit 36 in the inference phase.

First, the update learning model inference unit 36 processes the target model (model to be updated), the data used in building the model to be updated (model-to-be-updated building data), and the data acquired in operating the model (data acquired in operation) that are inputted to the model update and development system 1 (step S15). Note that like step S1 of the learning phase, the data process here refers to various processes, such as a data preprocess, a statistical data process, such as the process and complementing of a missing value, and the process of an outlier value, and error check.

Next, the update learning model inference unit 36 acquires the edge information of the inputted model (step S16). Note that this step performs the same process as step S2.

Next, the update learning model inference unit 36 creates the feature amount data by using the model-to-be-updated building data and the data acquired in operation (step S17). The creation of this feature amount can be achieved by the same method as step S3 of the learning phase.

Next, the update learning model inference unit 36 infers the updated model by using the update learning model acquired in the learning phase (step S18). As the inference method, the input acquired in step S16 is the edge information and the feature amount data of the model to be updated. Then, the update learning model inference unit 36 performs the same process as steps S10 and S11 of the learning phase, and infers the edge information of the updated model.

Next, the update learning model inference unit 36 uses, as the updated model, the model holding the inferred edge information, and outputs the model (step S19). In this case, it is desirable to display the model on the display unit 20 by using the update learning model display unit 24.

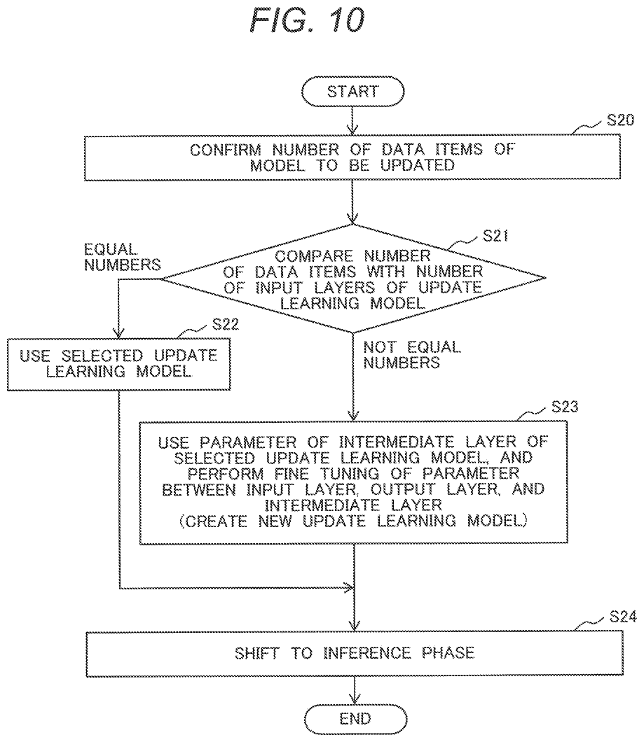

Next, FIG. 10 is a flowchart illustrating an example of the processing flow of the control unit 30 in the development phase. This flowchart is executed by the update learning model development unit 37.

First, the update learning model development unit 37 receives, as an input, the model to be updated, and confirms the number of data items thereof (step S20). That is, the number of data items is measured.

Next, the update learning model development unit 37 compares the number of data items that has been confirmed with the number of update learning models (step S21). As a result, when the numbers are equal, the update learning model development unit 37 changes to step S22. When the numbers are not equal, the update learning model development unit 37 changes to step S23.

Next, when the numbers are equal, the update learning model development unit 37 decides that the selected update learning model is used (step S22).

Also, when the numbers are not equal, the update learning model development unit 37 uses only the parameter of the intermediate layer of the selected update learning model. Then, the update learning model development unit 37 performs the fine tuning of the parameter between the input layer, the output layer, and the intermediate layer of the selected update learning model by the training data of the number of data items that is equal to the number of models to be updated. The update learning model development unit 37 causes this result to be a new update learning model, and stores the new update learning model in the storage unit 40 (step S23).

Next, the update learning model development unit 37 shifts to the inference phase (step S24). As a result, in the inference phase, the model to be updated can be updated by using the update learning model decided in step S21 or the update learning model stored in step S22.

### (4) Storage Unit 40

Next, the storage unit 40 will be described. The storage unit 40 is mainly configured of the model storage unit 41, an update learning model storage unit 42, an input data storage unit 43, the parameter storage unit 44, and an update learning model parameter storage unit 45. Note that for convenience, these are divided according to information stored, and may be configured of any number of configurations; for example, these are achieved by one housing. Next, various information stored in the storage unit 40 will be described.

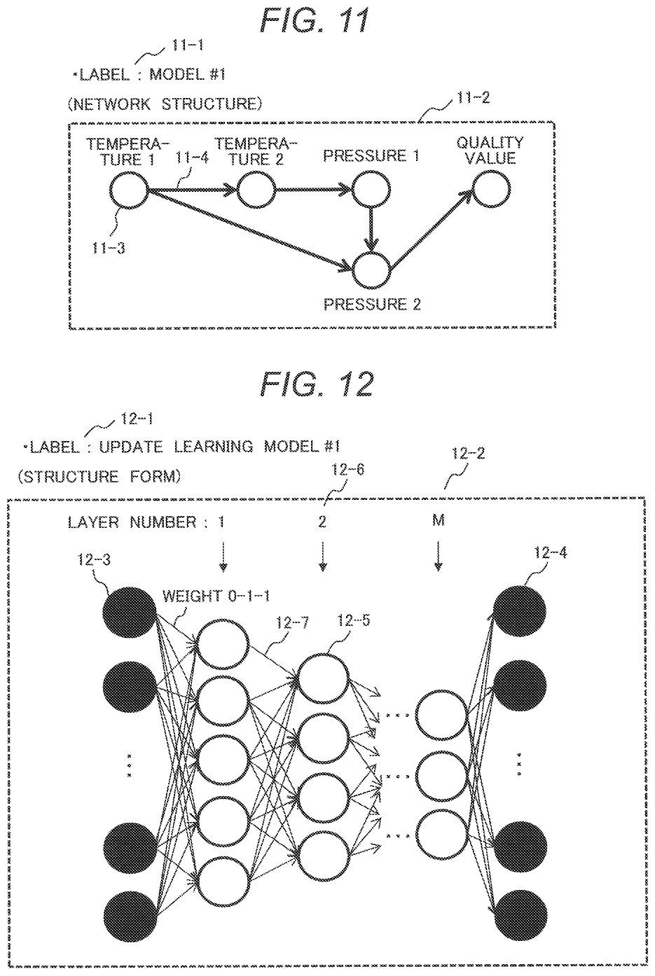

First, the contents stored in the model storage unit 41 will be described. FIG. 11 is a diagram illustrating a data structure example in a model network structure according to this embodiment. Specifically, this data includes the unupdated model and the updated model that are the training data, and the model inferred by the update learning model. Here, in this embodiment, the unupdated model, the updated model, and the model inferred by the update learning model are assumed to be a Bayesian network, and its format is illustrated in FIG. 11. Note that the assumed model is a Bayesian network model, but the present invention is not limited thereto.

The data illustrated in FIG. 11 includes label information (11-1) identifying the model and model information (11-2) represented by the network. Here, in this drawing, a representation equation in the network structure is used, and for each data item, a node (11-3) is indicated by a circle mark, and edge information (11-4) between the nodes is indicated by an arrow. In FIG. 11, when the edge is connected to a temperature 2 with respect to a temperature 1 in the first row, the network structure describes the edge in which the node of the temperature 1 is a start point and the node of the temperature 2 is an end point, between the node of the temperature 1 and the node of the temperature 2.

Next, FIG. 12 is a diagram illustrating a data structure example in a structure form of the update learning model according to this embodiment. That is, FIG. 12 illustrates the update learning model stored in the update learning model storage unit 42. In this embodiment, the update learning model is assumed to be the graph neural network, and its format is illustrated in FIG. 12.

In FIG. 12, the label (12-1) identifying the update learning model and the model are described in the structure form (12-2) that is the drawing represented in a structure form. In this structure form, the update learning model described in a table form is represented in a graph form. Here, in this drawing, the nodes (the input layer 12-3, the output layer 12-4) present in the input layer and the output layer of the model represented by the graph neural network are each represented by a solid circle, and the nodes (12-6) in the intermediate layer are each represented by an open circle. Here, the layer number indicates the number (12-6) of the intermediate layer, and the intralayer node indicates the number of nodes represented by the open circles of each layer number. Also, the weight number (12-7) for each layer number is the edge between the node in the input layer and the node in the intermediate layer, the edge between the nodes between the intermediate layers, or the edge between the node in the intermediate layer and the node in the output layer, and a weight is present in each of the edges.

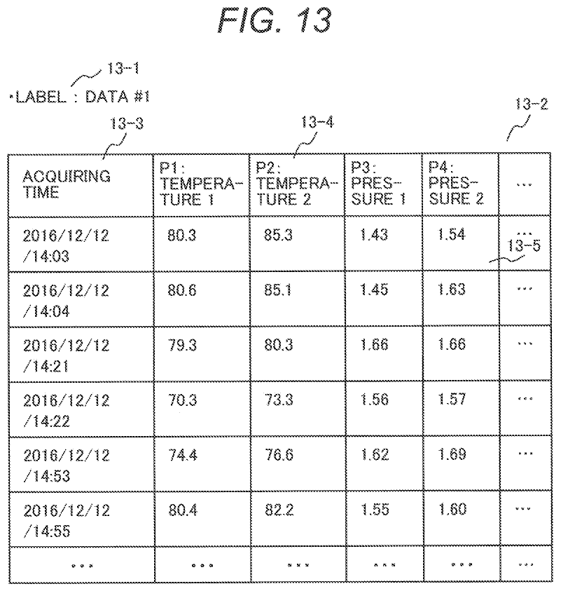

Next, FIG. 13 is a diagram illustrating a structure example of data in building the unupdated model, data in building the updated model, or data acquired in operation according to this embodiment. That is, FIG. 13 represents the unupdated model building data and the updated model building data as the training data stored in the input data storage unit 43, and the data acquired in operation.

In FIG. 13, label information (13-1) identifying the data and data information (13-2) described in a table form are described. In the data information (13-2) in a table form, the first row indicates the header information of each data item. And, the first column indicates acquiring time (13-3), and each of the second and subsequent columns indicates a data item (13-4). Note that the header information and arrangement are not limited to the example illustrated in FIG. 13. Also, in each of the second and subsequent rows, information (13-5) about the item described in each header is described. Also, in this embodiment, each data item for each acquiring time is described, but may be data described at, for example, a different granularity, such as the information of each data item for each product ID.

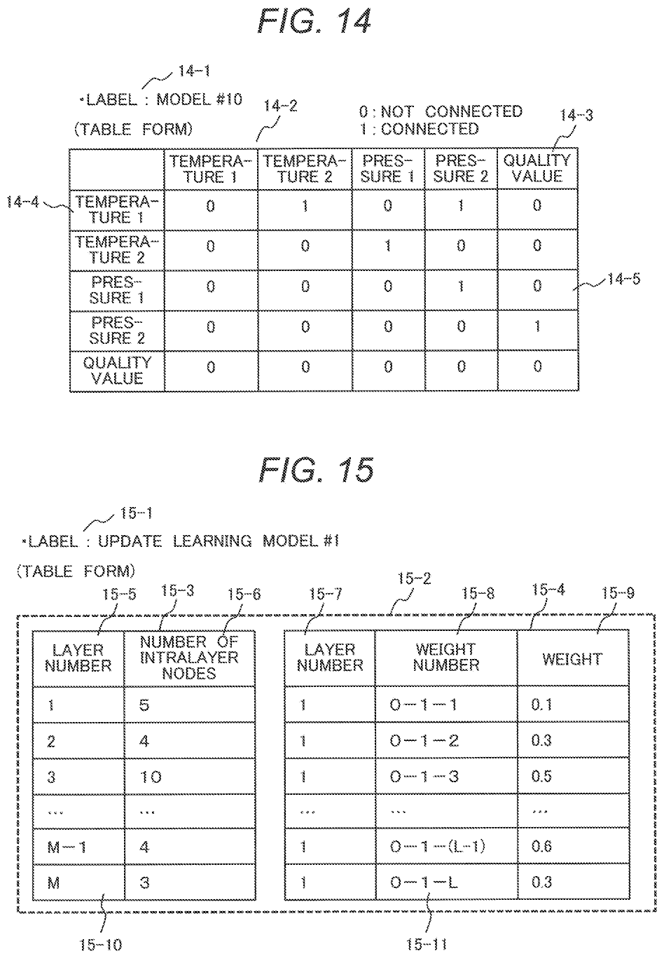

Next, FIG. 14 is a diagram illustrating a data structure example of edge information as the parameters of a model according to this embodiment. That is, FIG. 14 illustrates the edge information stored in the parameter storage unit 44. Here, in this embodiment, the unupdated model, the updated model, and the model inferred by the update learning model are assumed to be the Bayesian network, and its format that defines the edge information that is an example of the parameters is illustrated in FIG. 14.

In FIG. 14, the model is represented in a table form. This table form is described as a label (14-1) identifying the model and a table (14-2) including the edge information of the model. In the data information represented in the table (14-2), the first row indicates the data item (14-3) structuring the target model, and likewise, the first column indicates the data item (14-4) structuring the target model.

The edge information (14-5) between the data items described in the first row and the first column is described in each of the second and subsequent rows and the second and subsequent columns. Here, each data item in the first row is called a parent node with respect to each data item in the first column. When the edge is connected as means describing the edge information, 1 is described, and when the edge is not connected, 0 is described.

Next, FIG. 15 is a diagram illustrating a data structure example of the parameter information of the update learning model according to this embodiment. That is, FIG. 15 is a diagram illustrating the parameters of the update learning model stored in the update learning model parameter storage unit 45. Here, in this embodiment, the update learning model is assumed to be the graph neural network, and its format is described in FIG. 15.

In FIG. 15, a drawing in which each of these models is represented in a table form is described. In this table form, a label (15-1) identifying the update learning model and a graph neural (15-2) are described. The graph neural (15-2) is configured of a table (15-3) indicating a layer number and the number of intralayer nodes on the graph neural network and a table (15-4) holding a layer number, a number identifying weights thereof, and the weights.

Also, in the table (15-3), the first row includes, as headers, a layer number (15-5) identifying each layer in the graph neural network and the number of intralayer nodes (15-6) used by each layer number, and each of the second and subsequent rows includes a value (15-10) of each of the layer number and the number of intralayer nodes. In the table (15-4), the first row includes, as headers, a layer number (15-7), a weight number (15-8) identifying a weight in the layer, and a weight (15-9), and each of the second and subsequent rows describes a value (15-11) of each of the layer number, the weight number, and the weight.

### (5) Implementation Example

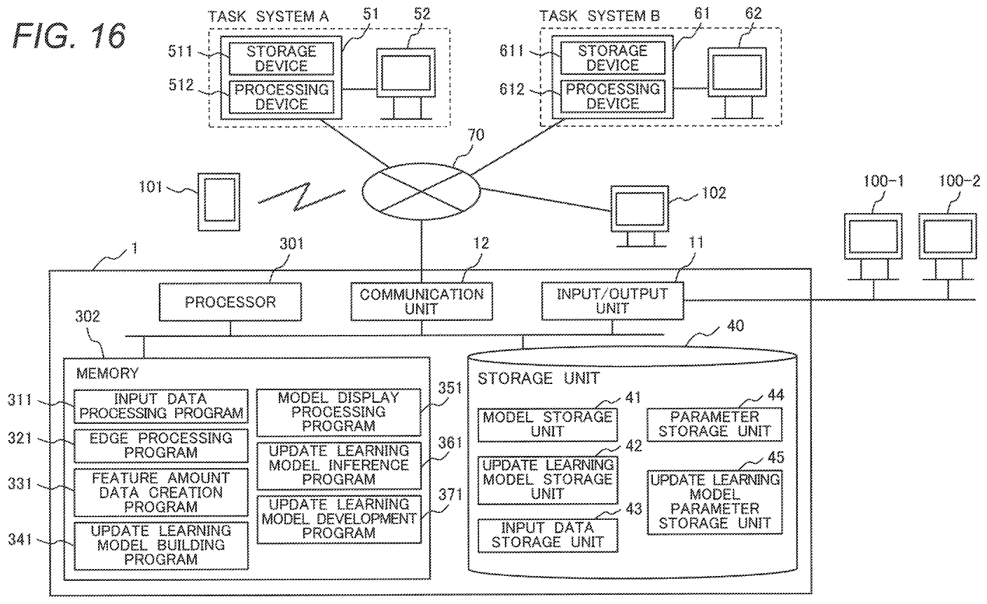

Next, an implementation example according to this embodiment will be described. FIG. 16 is a diagram illustrating the implementation example according to this embodiment. This implementation example is an example by which the model update and development system 1 is achieved as a cloud (server). In this implementation example, the model update and development system 1 is connected to a task system A, a task system B, a mobile terminal 101, and a terminal device 102 via a network 70. Hereinbelow, these respective devices will be described.

First, the model update and development system 1 can be achieved by the sever that is a sort of a computer. And, the model update and development system 1 has a processor 301, the communication unit 12, the input/output unit 11, a memory 302, and the storage unit 40 that are connected to each other via a communication path like a bus.

Here, the processor can be achieved by a processor like a CPU, and executes the process according to each program described later. This process is the process of the control unit 30 described above.

Also, the communication unit 12 and the input/output unit 11 are the same as the ones illustrated in FIG. 1. And, the communication unit 12 is connected to the network 70 like the Internet. Also, the input/output unit 11 is connected to user terminals 100-1 and 100-2 used by users. The user terminals 100-1 and 100-2 can be each achieved by a smartphone, a tablet, and a computer, such as a PC. Note that the user terminals 100-1 and 100-2 may be connected to the model update and development system 1 via the network 70 or its own network.

Also, the memory 302 develops information used for various programs and processes stored in the storage medium, such as the storage unit 40. The programs include an input data processing program 311, an edge processing program 321, a feature amount data creation program 331, an update learning model building program 341, a model display processing program 351, an update learning model inference program 361, and an update learning model development program 371. These are programs for respectively executing the same processes as the input data processing unit 31, the edge processing unit 32, the feature amount data creation unit 33, the update learning model building unit 34, the model display processing unit 35, the update learning model inference unit 36, and the update learning model development unit 37. That is, the processes of the control unit 30 are executed by the processor 301 and the memory 302. Note that in this implementation example, various processes are achieved on the basis of software called the programs, but the process of each unit illustrated in FIG. 1 may be executed by exclusive hardware or FPGA (field-programmable gate array).

Next, the storage unit 40 is the one illustrated in FIG. 1, and stores various information and programs described above. Note that the storage unit 40 may be implemented by a housing separated from the model update and development system 1.

Next, the task system A and the task system B are systems assisting various tasks by using the update learning model built in this embodiment and the model itself. In this embodiment, the model related to the task of the task system A can be developed to (or used in) the task system B that is another task. For example, the model of “the maintenance of an electric generation facility” of the task system A is developed to “the software management task” of the task system B.

Here, the task system A includes a server 51 including a storage device 511 and a processing device 512, and a terminal device 52. Also, the task system B includes a server 61 including a storage device 611 and a processing device 612, and a terminal device 62. That is, these can be achieved by a so-called computer system.

Also, the mobile terminal 101 and the terminal device 102 are used for various tasks described above. For example, the mobile terminal 101 and the terminal device 102 receive various processing results using the developed model, and display the results.

The present invention has been specifically described above on the basis of the embodiment of the present invention, but the present invention is not limited to the above embodiment, and needless to say, can be variously changed within the scope not departing from its purport. In particular, the model update may be executed by a device other than the model update and development system 1.

### REFERENCE SIGNS LIST

1 . . . Model update and development system
11 . . . Input/output unit
12 . . . Communication unit
20 . . . Display unit
21 . . . Model display unit
22 . . . Parameter display unit
23 . . . Update learning model selection unit
24 . . . Update learning model display unit
25 . . . Update learning model parameter display unit
30 . . . Control unit
31 . . . Input data processing unit
32 . . . Edge processing unit
33 . . . Feature amount data creation unit
34 . . . Update learning model building unit
35 . . . Model display processing unit
36 . . . Update learning model inference unit
37 . . . Update learning model development unit
40 . . . Storage unit
41 . . . Model storage unit
42 . . . Update learning model storage unit
43 . . . Input data storage unit
44 . . . Parameter storage unit
45 . . . Update learning model parameter storage unit

1. A model inference device that infers a model in machine learning, comprising:
a storage unit that stores an unupdated model as a model before update and an updated model;
a feature amount data creation unit that creates a feature amount indicating a feature related to an association between the unupdated model and the updated model in data used in updating the model;
an update learning model building unit that builds an update learning model learning an updating method of the update on the basis of the unupdated model, the updated model, and the feature amount; and
an updating learning model inference unit that infers the predetermined model on the basis of the update learning model.

2. The model inference device according to claim 1, wherein the feature amount data creation unit creates, as the feature amount, difference information indicating a difference between the unupdated model and the updated model.

3. The model inference device according to claim 2, wherein the update learning model building unit uses the unupdated model, data used in building the unupdated model, and data used in building the updated model to perform supervised learning in which the updated model is training data, thereby building the update learning model.

4. The model inference device according to claim 3,
wherein in the learning, the feature amount data creation unit creates, as the difference information, a difference between edge information as inferred parameter information and edge information given as the training data, and
wherein the update learning model building unit feeds back the difference information to the update learning model to build the update learning model.

5. The model inference device according to claim 1, wherein the model inference device further has an update learning model development unit that develops the model in a predetermined task on the basis of the update learning model.

6. A model inference method that uses a model inference device that infers a model in machine learning, comprising the steps of:
storing, in a storage unit, an unupdated model as a model before update and an updated model;
creating, by a feature amount data creation unit, a feature amount indicating a feature related to an association between the unupdated model and the updated model in data used in updating the model;
building, by an update learning model building unit, an update learning model learning an updating method of the update on the basis of the unupdated model, the updated model, and the feature amount; and
inferring, by an update learning model inference unit, the predetermined model on the basis of the update learning model.

7. The model inference method according to claim 6, wherein the feature amount data creation unit creates, as the feature amount, difference information indicating a difference between the unupdated model and the updated model.

8. The model inference method according to claim 7, wherein the update learning model building unit uses the unupdated model, data used in building the unupdated model, and data used in building the updated model to perform supervised learning in which the updated model is training data, thereby building the update learning model.

9. The model inference method according to claim 8,
wherein in the learning, the feature amount data creation unit creates, as the difference information, a difference between edge information as inferred parameter information and edge information given as the training data, and
wherein the update learning model building unit feeds back the difference information to the update learning model to build the update learning model.

10. The model inference method according to claim 6, wherein the model in a predetermined task is developed on the basis of the update learning model.

11. A program that causes a computer that is a model inference device that infers a model in machine learning to function as:
a storage unit that stores an unupdated model as a model before update and an updated model;
a feature amount data creation unit that creates a feature amount indicating a feature related to an association between the unupdated model and the updated model in data used in updating the model;
an update learning model building unit that builds an update learning model learning an updating method of the update on the basis of the unupdated model, the updated model, and the feature amount; and
an updating learning model inference unit that infers the predetermined model on the basis of the update learning model.

12. The program according to claim 11, wherein the feature amount data creation unit creates, as the feature amount, difference information indicating a difference between the unupdated model and the updated model.

13. The program according to claim 12, wherein the update learning model building unit uses the unupdated model, data used in building the unupdated model, and data used in building the updated model to perform supervised learning in which the updated model is training data, thereby building the update learning model.

14. The program according to claim 13,
wherein in the learning, the feature amount data creation unit creates, as the difference information, a difference between edge information as inferred parameter information and edge information given as the training data, and
wherein the update learning model building unit feeds back the difference information to the update learning model to build the update learning model.

15. The program according to claim 11, wherein the program further has an update learning model development unit that develops the model in a predetermined task on the basis of the update learning model.
